(19) United States
(12) Patent Application Publication
(10) Pub. No.: US 2022/0132456 A1
(43) Pub. Date: Apr. 28, 2022

(54) METHOD AND APPARATUS FOR MULTI-USIM OPERATIONS

(71) Applicant: Samsung Electronics Co., Ltd., Suwon-si (KR)

(72) Inventors: Rajavelsamy RAJADURAI, Bangalore (IN); Rohini RAJENDRAN, Bangalore (IN); Lalith KUMAR, Bangalore (IN); Varini GUPTA, Bangalore (IN); Nivedya Parambath SASI, Bangalore (IN)

(21) Appl. No.: 17/478,650

(22) Filed: Sep. 17, 2021

(30) Foreign Application Priority Data
Sep. 18, 2020 (IN) 202041040588
Sep. 9, 2021 (IN) 2020 41040588

(51) Int. Cl. H04W 60/00; H04W 8/02; H04W 8/18; H04W 76/30

(52) U.S. Cl. CPC H04W 60/00; H04W 76/30; H04W 8/18; H04W 8/02

(57) ABSTRACT

A method performed by a user equipment (UE) in a wireless communication system comprises: identifying whether the UE supports and intends to use at least one multi-universal subscriber identity module (USIM) feature; transmitting, to an access and mobility management function (AMF) entity, a registration request message including information of multi-USIM features supported by the UE, in a case that the at least one multi-USIM feature being supported and intended to use by the UE is identified; receiving, from a base station (BS), a registration accept message including an indication of multi-USIM features for the UE based on the registration request message, and wherein the indication of multi-USIM features for the UE is identified by the AMF based on network information and the information of multi-USIM features; and identifying at least one multi-USIM feature indicated as supported for the UE by the AMF based on the registration accept message.

### CROSS-REFERENCE TO RELATED APPLICATIONS

The present application claims priority to Indian Provisional Patent Application No. 202041040588, filed on Sep. 18, 2020, and Indian Complete Patent Application No. 202041040588, filed on Sep. 9, 2021. The content of the above-identified patent documents is incorporated herein by reference.

### BACKGROUND

### 1. Field

The present disclosure relates to wireless communication, and more specifically related to a method, a User Equipment (UE), and network entities for initiating/using a Multi Universal Subscriber Identity Module (MUSIM) optimization.

### 2. Description of Related Art

To meet the demand for wireless data traffic having increased since deployment of 4th generation (4G) communication systems, efforts have been made to develop an improved 5th generation (5G) or pre-5G communication system. The 5G or pre-5G communication system is also called a ‘beyond 4G network’ or a ‘post long term evolution (LTE) system’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beamforming, and large scale antenna techniques are discussed with respect to 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

In the 5G system, hybrid frequency shift keying (FSK) and Feher's quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud RAN as the above-described big data processing technology may also be considered to be as an example of convergence between the 5G technology and the IoT technology.

As described above, various services can be provided according to the development of a wireless communication system, and thus a method for easily providing such services is required.

### SUMMARY

Accordingly, embodiments herein achieve a method for operating a User Equipment (UE) supporting Multi Universal Subscriber Identity Module (MUSIM) optimization.

In accordance with an aspect of the disclosure, a method performed by a user equipment (UE) in a wireless communication system is provided. The method includes identifying whether the UE supports and intends to use at least one multi-universal subscriber identity module (USIM) feature; transmitting, to an access and mobility management function (AMF) entity, a registration request message including information of multi-USIM features supported by the UE, in a case that the at least one multi-USIM feature being supported and intended to use by the UE is identified; receiving, from a base station (BS), a registration accept message including an indication of multi-USIM features for the UE based on the registration request message, and wherein the indication of multi-USIM features for the UE is identified by the AMF based on network information and the information of multi-USIM features; and

identifying at least one multi-USIM feature indicated as supported for the UE by the AMF based on the registration accept message.

In an exemplary embodiment, wherein the information of multi-USIM features supported by the UE includes the at least one multi-USIM feature being supported and intended to use by the UE, and wherein the at least one multi-USIM feature corresponds to a connection release, a paging cause, a paging restriction, or a reject paging.

In an exemplary embodiment, wherein the indication of multi-USIM features for the UE includes at least one multi-USIM feature being supported and intended to apply to the UE by the AMF, and wherein the at least one multi-USIM feature corresponds to a connection release, a paging cause, a paging restriction, or a reject paging.

In an exemplary embodiment, wherein identifying whether the UE supports and intends to use the at least one multi-USIM feature comprises: identifying whether at least one USIM is active among at least two operating USIMs.

In an exemplary embodiment, wherein the indication of multi-USIM features for the UE is included in an N2 message from the AMF to the BS.

In an exemplary embodiment, wherein the indication of multi-USIM feature for the UE is identified by the AMF based on at least one of a network capability, a pre-configured local policy, or a preference policy.

In an exemplary embodiment, wherein at least one multi-USIM feature indicated as supported for the UE is apply for at least one USIM among at least two operating USIMs.

In accordance with another aspect of the disclosure, a method performed by an access and mobility management function (AMF) entity in a wireless communication system is provided. The method includes receiving, from a user equipment (UE), a registration request message including information of multi-USIM features supported by the UE, in a case that the at least one multi-USIM feature being supported and intended to use by the UE is identified by the UE; identifying an indication of multi-USIM features for the UE based on network information and the information of multi-USIM features; and transmitting, to a base station (BS), a message including the indication of multi-USIM features for the UE, wherein at least one multi-USIM feature indicated as supported for the UE by the AMF is identified based on the registration accept message.

In an exemplary embodiment, wherein the information of multi-USIM features supported by the UE includes the at least one multi-USIM feature being supported and intended to use by the UE, and wherein the at least one multi-USIM feature corresponds to a connection release, a paging cause, a paging restriction, or a reject paging.

In an exemplary embodiment, wherein the indication of multi-USIM features for the UE includes at least one multi-USIM feature being supported and intended to apply to the UE by the AMF, and

wherein the at least one multi-USIM feature corresponds to a connection release, a paging cause, a paging restriction, or a reject paging.

In an exemplary embodiment, wherein whether at least one USIM is active among at least two operating USIMs is identified by the UE.

In an exemplary embodiment, wherein the indication of multi-USIM features for the UE is transmitted to the UE by the BS.

In an exemplary embodiment, wherein identifying the indication of multi-USIM features for the UE based on the network information and the information of multi-USIM features comprises:

identifying the indication of multi-USIM feature for the UE based on at least one of a network capability, a pre-configured local policy, or a preference policy.

In an exemplary embodiment, wherein at least one multi-USIM feature indicated as supported for the UE is apply for at least one USIM among at least two operating USIMs by the UE.

In accordance with another aspect of the disclosure, a user equipment (UE) in a wireless communication system is provided. The UE comprises a transceiver; and at least one processor coupled with the transceiver and configured to: identify whether the UE supports and intends to use at least one multi-universal subscriber identity module (USIM) feature, transmit, to an access and mobility management function (AMF) entity, a registration request message including information of multi-USIM features supported by the UE, in a case that the at least one multi-USIM feature being supported and intended to use by the UE is identified, receive, from a base station (BS), a registration accept message including an indication of multi-USIM features for the UE based on the registration request message, and wherein the indication of multi-USIM features for the UE is identified by the AMF based on network information and the information of multi-USIM features, and identify at least one multi-USIM feature indicated as supported for the UE by the AMF based on the registration accept message.

In an exemplary embodiment, wherein the at least one processor is configured to: identify whether at least one USIM is active among at least two operating USIMs.

The method includes receiving by an Access and Mobility Management Function (AMF) entity, a Non-access stratum (NAS) request message including a capability information of the UE, wherein the capability information includes at least one of a number of active MUSIM in the UE, MUSIM features supported by the UE and the MUSIM features intended to be used by the UE. Further, the method includes determining by the AMF entity, whether the UE is authorizing the AMF to initiate the MUSIM features intended to be used by the UE and whether the AMF supports the MUSIM features intended to be used by the UE. Further, the method includes sending by the AMF entity, a NAS response message including an indication that AMF supports the MUSIM features intended to be used by the UE.

Further, the method includes sending, by the AMF entity, an N2 message to a Radio Access Network (RAN) node indicating that the AMF support of the MUSIM features intended to be used by the UE.

In an embodiment, the AMF determines the support of the MUSIM features intended to be used by the UE based on one of a pre-configured local policy or a preference policy. A pre-configured local policy or a preference policy indicates whether the network (for example, AMF, gNB like so) supports the MUSIM features and even if network supports, whether the AMF is allowed or not allowed to provide MUSIM enhancements to the UEs. The pre-configured local policy or a preference policy may allow only certain MUSIM features and may not allowed certain MUSIM features.

In an embodiment, the UE uses the MUSIM features supported by the AMF entity based on receiving a registration accept message.

In an embodiment, one or more MUSIM features supported by UE include supporting at least one of a connection release, a paging cause, a paging restriction and a reject paging.

In an embodiment, the NAS request message is a registration request message and the NAS response message is a registration accept message.

In an embodiment, where determining by the AMF entity, whether the UE is authorizing the AMF entity to initiate the MUSIM features intended to be used by the UE and whether the AMF entity supports the MUSIM features intended to be used by the UE includes performing, by the AMF entity, one of, not initiating one or more MUSIM features in response to determining that the UE is not authorizing to initiate one or more MUSIM features, and determining whether the AMF entity is authorized to initiate one or more MUSIM features in response to determining that the UE is authorizing to initiate one or more MUSIM features. Further, the method includes performing, by the AMF entity, one of: not initiating one or more MUSIM features in response to determining that the AMF entity is not authorized to initiate one or more MUSIM features, and initiating the support for MUSIM optimization in response to determining that the AMF entity is authorized to initiate one or more MUSIM features, and sending MUSIM optimization supported indication to the UE.

In an embodiment, authorizing to initiate MUSIM optimization indicates that the UE supports and intends to use one or more MUSIM optimization.

In an embodiment, wherein one or more MUSIM features of the UE indicates that the UE supports at least one of a connection release, a paging cause, a paging restriction and a reject paging as MUSIM optimization capabilities.

In an embodiment, one or more MUSIM features of the UE indicates that at least one of the UE with the capabilities of Multi-USIM features and the UE does not support one or more Multi-USIM features.

In an embodiment, one or more MUSIM features of the UE indicates that the UE having one or more SIM is not subjected to one or more MUSIM features if not required.

In an embodiment, the method further includes determining, by the UE, whether one or more MUSIM features supported indication is received or not received from the AMF entity. Further, the method includes performing, by the UE, one of: using one or more MUSIM features when one or more MUSIM features supported indication is received from the AMF entity, and not using one or more MUSIM features when one or more MUSIM features supported indication is not received from the AMF entity.

In an embodiment, the method further includes receiving, by the UE, an input from a user of the UE, wherein the input indicates that the UE is authorized to initiate one or more MUSIM features, and the UE is not authorized to initiate one or more MUSIM features. Further, the method includes storing, by the UE, the input in a Subscriber Identity Module (SIM) card manager of the UE or a SIM Application Toolkit (SAT) of the UE. Further, the method includes using, by the UE, one or more MUSIM features when the received input indicates that one or more MUSIM features is supported indication.

Accordingly, embodiments herein achieve the AMF entity for operating a User Equipment (UE) supporting Multi Universal Subscriber Identity Module (MUSIM) optimization. The AMF entity includes a MUSIM optimizer coupled with a processor and a memory. The MUSIM optimizer receives a Non-access stratum (NAS) request message including a capability information of the UE, wherein the capability information includes at least one of a number of active MUSIM in the UE, MUSIM features supported by the UE and the MUSIM features intended to be used by the UE. Further, the MUSIM optimizer determines whether the UE is authorizing the AMF to initiate the MUSIM features intended to be used by the UE and whether the AMF supports the MUSIM features intended to be used by the UE. Further, the MUSIM optimizer sends a NAS response message including an indication that AMF supports the MUSIM features intended to be used by the UE.

Accordingly, embodiments herein achieve the UE for supporting Multi Universal Subscriber Identity Module (MUSIM) optimization. The UE includes a MUSIM optimizer coupled with a processor and a memory. The MUSIM optimizer receives an input from a user of the UE, wherein the input indicates that the UE is authorized to initiate one or more MUSIM features, and the UE is not authorized to initiate one or more MUSIM features. Further, the MUSIM optimizer stores the input in a Subscriber Identity Module (SIM) card manager of the UE or a SIM Application Toolkit (SAT) of the UE. The MUSIM optimizer uses one or more MUSIM features when the received input indicates that one or more MUSIM features is supported indication.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

This disclosure is illustrated in the accompanying drawings, throughout which like reference letters indicate corresponding parts in the various figures. The embodiments herein will be better understood from the following description with reference to the drawings, in which:

FIG. 1A illustrates a block diagram of a User Equipment (UE) for initiating a Multi Universal Subscriber Identity Module (MUSIM) optimization, according to an embodiment as disclosed herein;

FIG. 1B illustrates a block diagram of an Access and Mobility Management Function (AMF) entity for initiating the MUSIM optimization, according to an embodiment as disclosed herein;

FIG. 2 is a sequence diagram illustrating a method for initiating the MUSIM optimization, according to an embodiment as disclosed herein;

FIG. 3 is a sequence diagram illustrating an alternate method for initiating the MUSIM optimization, according to an embodiment as disclosed herein;

FIG. 4 is a sequence diagram illustrating an alternate method for initiating the MUSIM optimization, according to an embodiment as disclosed herein;

FIG. 5 is a sequence diagram illustrating an alternate method for initiating the MUSIM optimization, according to an embodiment as disclosed herein;

FIG. 6 is a sequence diagram illustrating an alternate method for initiating the MUSIM optimization, according to an embodiment as disclosed herein;

FIGS. 7A-7B are sequence diagrams illustrating an alternate method for initiating the MUSIM optimization, according to an embodiment as disclosed herein;

FIG. 8 is a sequence diagram illustrating an alternate method for initiating the MUSIM optimization, according to an embodiment as disclosed herein;

FIGS. 9A-9B are sequence diagrams illustrating an alternate method for initiating the MUSIM optimization, according to an embodiment as disclosed herein;

FIGS. 10A-10B are sequence diagrams illustrating an alternate method for initiating the MUSIM optimization, according to an embodiment as disclosed herein;

FIG. 11 is a sequence diagram illustrating an alternate method for initiating the MUSIM optimization, according to an embodiment as disclosed herein;

FIG. 12 is a sequence diagram illustrating an alternate method for initiating the MUSIM optimization which combines the various embodiment as disclosed herein;

FIG. 13 illustrates a user equipment (UE) according to embodiments of the present disclosure;

FIG. 14 illustrates a base station (BS) according to embodiments of the present disclosure; and

FIG. 15 illustrates an entity according to embodiments of the present disclosure.

### DETAILED DESCRIPTION

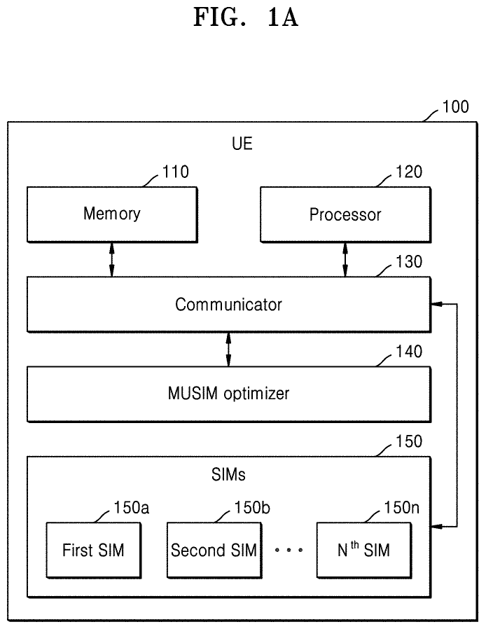

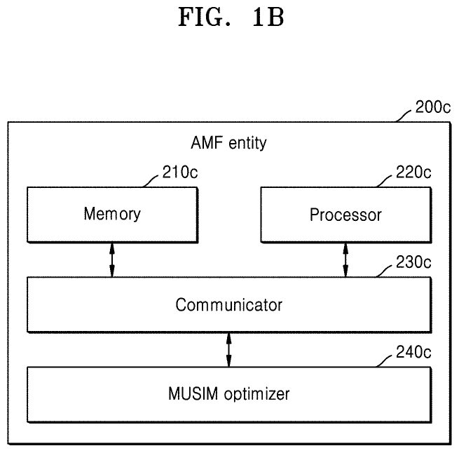

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

3rd Generation Partnership Project (3GPP) initiated a research to optimize network resources use (for example, paging). Standardizing support for Multi Universal Subscriber Identity Module (MUSIM) devices can improve performance by allowing network functionality to be based on predictable User Equipment (UE) behavior. When a user switches communications between various networks, the UE may no longer be able to receive data from the network with which it was recently communicating. Such situations may have a negative impact on performance, e.g., if pages are sent by the network and not properly received at the UE, or if users are scheduled to receive paging messages while not being able to receive communication.

In an existing system, there is no coordination possible/required between a Universal Mobile Telecommunication System (UMTS) Subscriber Identity Module(s) (USIM(s)) and/or between a mobile network operator(s) and there is no optimization for handling multiple SIMS (e.g. USIM(s)), which may belong to same or different operators. The USIM(s) can be a physical SIM card or an integrated SIM or an embedded Subscriber Identity Module (eSIM). As the USIM(s) may belong to various mobile network operators, the mobile network operator(s) (e.g. network server) may have privacy concerns about sharing USIM(s) data (implicit) with another mobile network operator(s). For example, to avoid subscriber poaching. Furthermore, based on regional legal requirements/rules, a certain mobile network operator(s) may have privacy concerns regarding providing USIM(s) data (e.g. subscriber(s) data, personal information, SIM information, etc.) with another mobile network operator(s). The existing system does not provide any optimal mechanism to manage MUSIM optimizations (e.g. sharing or not sharing USIM(s) data with another mobile network operator(s)). Thus, it is desired to provide a useful alternative for the initiate/use MUSIM optimizations only when intended by the UE and the network.

The principal object of the embodiments herein is to obtain consent from a subscriber (e.g. UE/user) and/or from a Home Network (HN) (e.g. Unified data management (UDM) entity) and/or from a Serving Network (SN) (e.g. Access and Mobility Management Function (AMF) entity), to share/expose information of one operator with another operator and/or information about possession of multiple (more than one) active SIMs in the UE for performance improvement.

Another object of the embodiment herein is to initiate MUSIM optimizations based on consent(s) and capabilities of the UE, the SN, and the HN. The capability of the UE includes one or more MUSIM features when the UE is authorized to initiate the MUSIM optimization (one or more MUSIM features), where one or more MUSIM features includes a connection release support, a paging cause support, a paging restriction support, and a reject paging supported.

Throughout this disclosure, the terms “AMF entity” and “AMF” are used interchangeably and mean the same. The terms “UDM entity” and “UDM” are used interchangeably and mean the same. The terms “MUSIM consent” and “consent” are used interchangeably and mean the same. The terms “network entities” and “network” are used interchangeably and mean the same. The terms “authorizing to initiate MUSIM optimization” and “consent” are used interchangeably and mean a UE supports and intends to use one or more MUSIM optimization. The term “MUSIM optimization” means one or more following Multi-USIM features: connection release, paging cause, paging restriction and reject paging as MUSIM optimization capabilities. The terms “MUSIM” and “Multi-SIM” are used interchangeably and mean use of multiple USIMs within the UE.

In conventional methods and systems, privacy concerns arise when a user of a User Equipment (UE) has options of having both a personal USIM(s) and a business USIM(s) (i.e. phone number) or multiple USIM(s) within the same UE. Many business USIM(s)/phone(s) would allow remote control/management from an owner of a business and would not allow any USIM(s) information to be shared with another mobile network operator(s) according to corporate policies. In addition, there may be a corporate policy that prohibits corporate employees from interrupting current sessions of the business USIM(s). For example, a paging cause received in a paging message of the personal USIM(s) should not halt active connections of business connection/business USIM(s), which exposes that the UE supports dual active SIMS.

Consider another example in which the user has subscriptions with two operators (A and B), or the UE supports/uses dual active USIM(s). In this case, the operators (A and B) may have no idea whether a subscriber is using two USIM(s) or not. If the UE informs operator-A without a user's permission that the user is utilizing another subscription with the operator-B. In that case, the user may be concerned that the operator-A may not provide preferential treatment if the operator-A is aware that the user is not a valued customer or that the subscriber intends to leave. In such an example, the existing system does not provide any optimal mechanism to manage MUSIM optimizations (e.g. sharing or not sharing USIM(s) data/personal information with another mobile network operator(s)) at the UE.

Consider another example in which the UE and/or the network want to share the USIM(s) data with another mobile network operator(s) (e.g. 3rd party server(s)). When the UE indicates to the mobile network operator using one USIM that the UE is also utilizing another USIM, there is a security concern if the mobile network operator has privacy concerns when collaborating with another mobile network operator(s). If the mobile network operator informs the UE that it's identities should not be registered with another mobile network operator(s), the UE should not be authorized to do so. The reason for unwillingness to collaborate may be: no support of feature(s) and also is unwilling to update the mobile network operator to support or based on subscription (request from the subscriber) or because of the user's low tariff subscription or based on subscription tariff (e.g. the user opted, even though the UE (User) wants to share USIM details (of Operator A) to the operator B, the operator A should allow sharing details and it can depend on inter-operator billing. For example, charging specifically for sharing the details based on the type of information. Maintaining the application priorities and indicating the cause of paging, like so.), no support for that particular subscriber (for example, no Value Added Services (VAS)). In such an example, the existing system does not provide any optimal mechanism to manage MUSIM at the UE, the mobile network operator, and the other mobile network operator(s).

Accordingly, embodiments herein achieve a method for operating a User Equipment (UE) supporting Multi Universal Subscriber Identity Module (MUSIM) optimization. The method includes receiving by an Access and Mobility Management Function (AMF) entity, a Non-access stratum (NAS) request message including a capability information of the UE, wherein the capability information includes at least one of a number of active MUSIM in the UE, MUSIM features supported by the UE and the MUSIM features intended to be used by the UE. Further, the method includes determining by the AMF entity, whether the UE is authorizing the AMF to initiate the MUSIM features intended to be used by the UE and whether the AMF supports the MUSIM features intended to be used by the UE. Further, the method includes sending by the AMF entity, a NAS response message including an indication that AMF supports the MUSIM features intended to be used by the UE.

Accordingly, embodiments herein achieve the AMF entity for operating a User Equipment (UE) supporting Multi Universal Subscriber Identity Module (MUSIM) optimization. The AMF entity includes a MUSIM optimizer coupled with a processor and a memory. The MUSIM optimizer receives a Non-access stratum (NAS) request message including a capability information of the UE, wherein the capability information includes at least one of a number of active MUSIM in the UE, MUSIM features supported by the UE and the MUSIM features intended to be used by the UE. Further, the MUSIM optimizer determines whether the UE is authorizing the AMF to initiate the MUSIM features intended to be used by the UE and whether the AMF supports the MUSIM features intended to be used by the UE. Further, the MUSIM optimizer sends a NAS response message including an indication that AMF supports the MUSIM features intended to be used by the UE.

Accordingly, embodiments herein achieve the UE for supporting Multi Universal Subscriber Identity Module (MUSIM) optimization. The UE includes a MUSIM optimizer coupled with a processor and a memory. The MUSIM optimizer receives an input from a user of the UE, wherein the input indicates that the UE is authorized to initiate one or more MUSIM features, and the UE is not authorized to initiate one or more MUSIM features. Further, the MUSIM optimizer stores the input in a Subscriber Identity Module (SIM) card manager of the UE or a SIM Application Toolkit (SAT) of the UE. The MUSIM optimizer uses one or more MUSIM features when the received input indicates that one or more MUSIM features is supported indication.

Unlike existing methods and systems, the proposed method allows the UE/AMF/SDM to obtain a consent from a subscriber (e.g. UE/user) and/or from an HN (e.g. UDM entity) and/or from an SN (e.g. AMF entity), to share/expose information of one operator with another operator and/or information about possession of multiple (more than one) active SIMs in the UE for performance improvement.

Unlike existing methods and systems, the proposed method allows the UE/AMF/SDM to initiate/use one or more MUSIM features based on the consent(s) and capabilities of the UE, the SN, and the HN. The capabilities of the UE include one or more MUSIM features when the UE is authorized to network to initiate/use one or more MUSIM features, where one or more MUSIM features include a connection release support, a paging cause support, a paging restriction support, and a reject paging support.

As mentioned in the proposed method, the UE is allowed to share information about the possession of multiple (more than one) active SIMs in the UE or initiate one or more MUSIM features, to increase the performance, but not limited to:

a. Enhancement(s) to address the collision due to reception of paging when the UE is in idle/inactive mode in both the networks associated with respective USIMs.

b. The UE to notify Network A of its switch from Network A (for MUSIM purpose).

c. An incoming page to indicate to the UE whether the service is Voice over Long-Term Evolution (VoLTE)/Voice over New Radio (VoNR).

d. Handling of Mobile Terminated service destined to USIM A while the UE is actively communicating with USIM B.

e. Co-ordinate leaving and resumption of an ongoing connection in the 3rd Generation Partnership Project (3GPP) system associated with USIM A, so that the UE can temporarily leave to the 3GPP system associated with USIM B, and then return to the 3GPP system associated with USIM A in a network-controlled manner.

f. Enabling paging reception in a MUSIM device.

g. Handling of service prioritization i.e. whether the UE behavior upon reception of paging information is driven by USIM configuration or user preferences or both.

In an embodiment, procedures mentioned from a-g comes under one or more MUSIM features procedures such as connection release supported, paging cause supported, paging restriction supported, reject paging supported, collectively has been referred as one or more MUSIM features.

In an embodiment, the proposed method allows the UE to obtain the consent from the subscriber and/or from a Home Network (HN) and/or from a Serving Network (SN), to share/expose the information of one operator with another operator and/or information about the possession of multiple (more than one) active SIMs. The consent (or configuration) indicates explicitly whether there is the user's and/or network's willingness to obtain/provide one or more MUSIM features. The SN determines whether to provide one or more MUSIM features or not and indicate its decision to the UE based on the user s consent/authorization, the HN s authorization/indication/consent, and SN's policy (local policy/consent), even though the UE, the HN, and the SN are capable of one or more MUSIM features. Based on the indication from the network (i.e. HN, SN), the UE decides whether to support one or more MUSIM features s or not. The UE and network do not provide/initiate the MUSIM optimizations (one or more MUSIM features) if:

a. The user does not provide the consent to disclose user's personal information;

b. Indication of the HN does not support/provide the MUSIM optimization for the subscription (based on subscription or based on SLA with SN); and

c. Indication of the SN does not prefer to support/provide the MUSIM optimization for the subscriber/roaming subscriber.

Referring now to the drawings and more particularly to FIGS. 1A through 12, where similar reference characters denote corresponding features consistently throughout the figures, there are shown preferred embodiments.

FIG. 1A illustrates a block diagram of a User Equipment (UE) (100) for initiating a Multi Universal Subscriber Identity Module (MUSIM) optimization, according to an embodiment as disclosed herein. Examples of the UE (100) include, but are not limited to a smartphone, a tablet computer, a Personal Digital Assistance (PDA), an Internet of Things (IoT) device, a wearable device, etc.

In an embodiment, the UE (100) includes a memory (110), a processor (120), a communicator (130), a MUSIM optimizer (140), and a plurality of SIMS (150).

In an embodiment, the memory (110) stores a user input/consent for one or more MUSIM features, a capability of the UE (100), a number of active SIMs in the UE (100), and information indicates that one of the UE (100) is authorized to initiate one or more MUSIM features, and the UE (100) is not authorized to initiate one or more MUSIM features. The memory (110) stores instructions to be executed by the processor (120). The memory (110) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) can be configured to store larger amounts of information than the memory. In certain examples, a non-transitory storage medium may store data that can, over time, change (e.g., in Random Access Memory (RAM) or cache). The memory (110) can be an internal storage unit or it can be an external storage unit of the UE (100), a cloud storage, or any other type of external storage.

The processor (120) communicates with the memory (110), the communicator (130), and the MUSIM optimizer (140), and the plurality of SIMS (150). The processor (120) executes instructions stored in the memory (110) and to perform various processes. The processor (120) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (130) is configured for communicating internally between internal hardware components and with external devices (e.g. eNodeB, gNodeB, server, AMF, UDM, etc.) via one or more networks (e.g. Radio technology). The communicator (130) includes an electronic circuit specific to a standard that enables wired or wireless communication.

The MUSIM optimizer (140) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

The MUSIM optimizer (140) determines whether one or more MUSIM features supported indication is received or not received from the AMF entity (200c). Further, the MUSIM optimizer (140) performs one of: using one or more MUSIM features when one or more MUSIM features supported indication is received from the AMF entity (200c), and not using one or more MUSIM features when one or more MUSIM features supported indication is not received from the AMF entity (200c).

Further, the MUSIM optimizer (140) receives an input from a user of the UE (100), wherein the input indicates that the UE (100) is authorized to initiate one or more MUSIM features, and the UE (100) is not authorized to initiate one or more MUSIM features. Further, the MUSIM optimizer (140) stores the input in a Subscriber Identity Module (SIM) card manager of the UE (100) or a SIM Application Toolkit (SAT) of the UE (100). Further, the MUSIM optimizer (140) uses one or more MUSIM features when the received input indicates that one or more MUSIM features is supported indication.

Although the FIG. 1A shows various hardware components of the UE (100) but it is to be understood that other embodiments are not limited thereon. In other embodiments, the UE (100) may include less or more number of components. Further, the labels or names of the components are used only for illustrative purpose and does not limit the scope of the disclosure. One or more components can be combined together to perform same or substantially similar function to initiate one or more MUSIM features.

FIG. 1B illustrates a block diagram of an Access and Mobility Management Function (AMF) entity (200c) for initiating the MUSIM optimization, according to an embodiment as disclosed herein.

In an embodiment, the AMF entity (200c) includes a memory (210c), a processor (220c), a communicator (230c), and a MUSIM optimizer (240c).

In an embodiment, the memory (210c) stores the user input/consent for MUSIM optimization, the capability of the UE (100), the number of active SIMS in the UE (100), and information indicates that one of the UE (100) and/or a UDM (200b) is authorized to initiate the MUSIM optimization (i.e. one or more MUSIM features), and the UE (100) and/or the UDM (200b) is not authorized to initiate the MUSIM optimization. The memory (210c) stores instructions to be executed by the processor (220c). The memory (210c) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (210c) may, in some examples, be considered a non-transitory storage medium. The term “non-transitory” may indicate that the storage medium is not embodied in a carrier wave or a propagated signal. However, the term “non-transitory” should not be interpreted that the memory (210c) is non-movable. In some examples, the memory (210c) can be configured to store larger amounts of information than the memory. In certain examples, a non-transitory storage medium may store data that can, over time, change (e.g., in Random Access Memory (RAM) or cache). The memory (210c) can be an internal storage unit or it can be an external storage unit of the AMF entity (200c), a cloud storage, or any other type of external storage.

The processor (220c) communicates with the memory (210c), the communicator (230c), and the MUSIM optimizer (240c). The processor (220c) executes instructions stored in the memory (210c) and to perform various processes. The processor (220c) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (230c) is configured for communicating internally between internal hardware components and with external devices (e.g. eNodeB, gNodeB, server, UE, UDM, etc.) via one or more networks (e.g. Radio technology). The communicator (230c) includes an electronic circuit specific to a standard that enables wired or wireless communication.

The MUSIM optimizer (240c) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the MUSIM optimizer (240c) receives a Non-access stratum (NAS) request message including a capability information of the UE (100), wherein the capability information includes at least one of a number of active MUSIM (150) in the UE (100), MUSIM features supported by the UE (100) and the MUSIM features intended to be used by the UE (100). Further, the MUSIM optimizer (240c) determines whether the UE (100) is authorizing the AMF entity (200c) to initiate the MUSIM features intended to be used by the UE (100) and whether the AMF entity (200c) supports the MUSIM features intended to be used by the UE (100). Further, the MUSIM optimizer (240c) sends a NAS response message including an indication that AMF entity (200c) supports the MUSIM features intended to be used by the UE (100).

Further, the MUSIM optimizer (240c) sends an N2 message to a Radio Access Network (RAN) node (200A) indicating that the AMF entity (200c) support of the MUSIM features intended to be used by the UE (100).

The AMF entity (200c) determines the support of the MUSIM features intended to be used by the UE (100) based on one of a pre-configured local policy or a preference policy. The local policy or preference policy is a pre-configured local policy or a preference policy indicates whether the network (for example, AMF, gNB like so) supports MUSIM features and even if network supports, whether the AMF is allowed or not allowed to provide MUSIM enhancements to the UE (100)s. The pre-configured local policy or a preference policy may allow only certain MUSIM features and may not allowed certain MUSIM features. The UE (100) uses the MUSIM features supported by the AMF entity (200c) based on receiving a registration accept message. one or more MUSIM features supported by UE (100) include supporting at least one of a connection release, a paging cause, a paging restriction and a reject paging. The NAS request message is a registration request message and the NAS response message is a registration accept message.

Further, the MUSIM optimizer (240c) perform one of: not initiating one or more MUSIM features in response to determining that the UE (100) is not authorizing to initiate one or more MUSIM features, and determining whether the AMF entity (200c) is authorized to initiate one or more MUSIM features in response to determining that the UE (100) is authorizing to initiate one or more MUSIM features. Further, the MUSIM optimizer (240c) perform one of: not initiating one or more MUSIM features in response to determining that the AMF entity (200c) is not authorized to initiate one or more MUSIM features, and initiating the support for MUSIM optimization in response to determining that the AMF entity (200c) is authorized to initiate one or more MUSIM features, and sending MUSIM optimization supported indication to the UE (100).

In an embodiment, authorizing to initiate MUSIM optimization indicates that the UE (100) supports and intends to use one or more MUSIM optimization. one or more MUSIM features of the UE (100) indicates that the UE (100) supports at least one of a connection release, a paging cause, a paging restriction and a reject paging as MUSIM optimization capabilities. one or more MUSIM features of the UE (100) indicates that at least one of the UE (100) with the capabilities of Multi-USIM features and the UE (100) does not support one or more Multi-USIM features. one or more MUSIM features of the UE (100) indicates that the UE (100) having one or more SIM is not subjected to one or more MUSIM features if not required.

Although the FIG. 1B shows various hardware components of the AMF entity (200c) but it is to be understood that other embodiments are not limited thereon. In other embodiments, the AMF entity (200c) may include less or more number of components. Further, the labels or names of the components are used only for illustrative purpose and does not limit the scope of the disclosure. One or more components can be combined together to perform same or substantially similar function to initiate one or more MUSIM features.

In an embodiment, a dual USIM device (i.e. UE (100)) a paging cause is included in a paging message and for a single USIM device (i.e. UE (100)), a paging cause is not included, then implicitly exposing private information of the user by including the paging cause will be a threat. The user does not want its paging cause to be traced, then the user may not choose the UE (100) as dual USIM capable and hence not indicating to the network (200a/200b/200c) that this is the dual USIM device with dual USIM activated should be of user s choice. The condition for sharing the details or providing the user consent should be based on (one of):

a. In-Home network (e.g. UDM entity (200b)): The subscriber/user information should indicate whether or not sharing the details between the operators should be based on one of:

i. Subscribers consent (even though network (200a/200b/200c) & the UE (100) supports, user is not willing to share this info); and

ii. Consent/authorization of the UDM (200b) (based on a business relationship, a subscribed billing plan).

b. In-Serving network (e.g. AMF entity (200c)): Along with the subscription information, an AMF entity capability to support the MUSIM operations requested by the UE (100) should be considered, its consent, and its policy with the UDM entity (200b).

In an embodiment, an indication has to be sent by the UDM entity (200b) and/or AMF entity (200c) to the UE (100) whether to share the information of its network with other network operators. The UDM entity (200b) and/or AMF entity (200c) may provide the UE (100) with a “list of allowed Public Land Mobile Network (PLMN)'s IDs and/or a “list of forbidden PLMN IDs”, based on which the UE (100) shares the USIM information and/or request and obtain MUSIM optimizations with the other network operators.

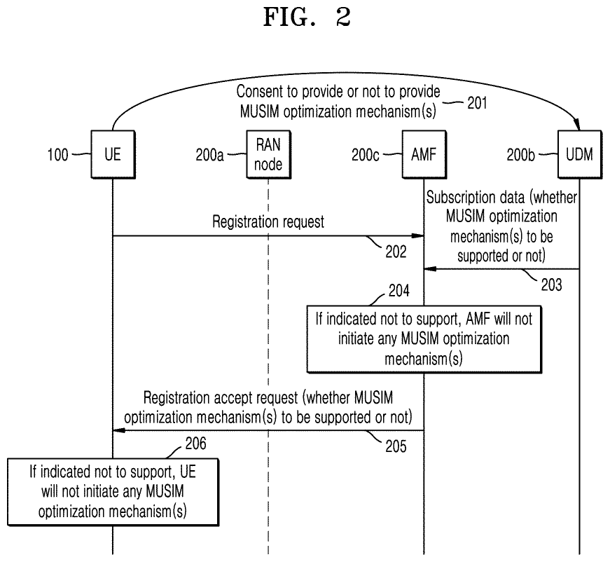

In an embodiment, the solutions (FIG. 2 to FIG. 15) provided in this specification are performed as per subscription basis, irrespective of HPLMNs are different or the same.

In an embodiment, the authorization information/indication applies to only that USIM (150), and the information related to that USIM should not be used, if not authorized, even if another USIM (150) is authorized to obtain one or more MUSIM features. It shall be possible to combine steps from different solution alternatives to have a solution.

FIG. 2 is a sequence diagram illustrating a method for initiating the MUSIM optimization, according to an embodiment as disclosed herein.

In this scenario, the method is assumed that one of the UE (100), the UDM (200b) (i.e. Home Network (HN)), and the AMF (200c) (i.e. Serving Network (SN)) is capable of the MUSIM optimization/support. The user (subscriber) of the UE (100) provided users consent by some means to the UDM (200b). For example, during a subscription purchase process or indicated the user s consent to the UDM (200b) via a Short Message Service (SMS) or via a web interface to a portal of the UDM (200b). However, based on the user s consent, the AMF (200c) may determine whether to provide the MUSIM optimizations or not, and the AMF (200c) indicates a decision to the UE (100). Based on the indication received from the AMF (200c), the UE (100) decides whether to support the MUSIM optimizations or not. If the user of the UE (100) does not provide the consent to disclose its information, then the UE (100) and network (e.g. the UDM (200b), the AMF (200c)) does not support the MUSIM optimizations.

At step 201, the UE (100) provides MUSIM consent information to the UDM (200b). The MUSIM consent information includes whether or not the UE (100) provides the MUSIM optimization (i.e., whether or not the UE (100) supports and intends to use one or more Multi-USIM specific features). At step 202, the UE (100) initiates a registration procedure by sending a registration request message to the AMF (200c). The UE (100) includes a necessary procedure required for the registration in this message. At step 203, as part of the registration procedure, the UDM (200b) provides the AMF (200c) with the subscription data, if requested by the AMF (200c). The subscription data may have the MUSIM consent information that includes whether or not to use/provide the MUSIM optimizations. In addition to or as an alternative to the MUSIM consent information provided in the subscription data by the UDM (200b), a Policy Control function (PCF) provides the information to the AMF (200c) about the MUSIM consent information and/or the local policy on whether to support the MUSIM optimizations or not.

At step 204, the AMF (200c) determines whether to initiate the MUSIM optimizations or not. The AMF (200c) proceeds with the MUSIM optimizations based on the information provided in the subscription data and/or in the PCF-provided policies.

At step 205, the AMF (200c) sends a registration accept message indicating to the UE (100) whether to support/initiate the MUSIM optimizations or not. In an embodiment, in addition to or an alternative to the MUSIM consent information provided by the AMF (200c) (FIG. 2, at step 206), the PCF provides information on the MUSIM consent or authorization to the UE (100) using a UE configuration update procedure. In an embodiment, the authorization information/indication for the MUSIM optimizations is provided by the AMF (200c) to the RAN (eNB/gNB) (200a), using a UE context setup/modification procedure. Only if the RAN (200a) receives information/indication that MUSIM optimization is authorized, then the RAN (200a) provides the MUSIM optimizations to the UE (100). In an embodiment, an illustrated representation of the indication from the AMF (200c) to the UE (100) is shown in Table 1.

TABLE 1

| Attribute | | |
|---|---|---|
| name | Data type | Description |
| MUSIM | Boolean | This indicates that the UE is |
| optimization | | allowed for MUSIM optimization |
| | | for the associated |
| | | USIM/subscription. |
| | | True or “1”: indicates that the UE is |
| | | allowed for MUSIM optimizations |
| | | for the associated |
| | | USIM/subscription. |
| | | False or absent or “0”: indicates |
| | | that the UE is not allowed for |
| | | MUSIM optimizations for the |
| | | associated USIM/subscription. |

At step 206, in response to receiving the indication that not to use any MUSIM optimization-related procedure, the UE (100) should not initiate or use any such procedures.

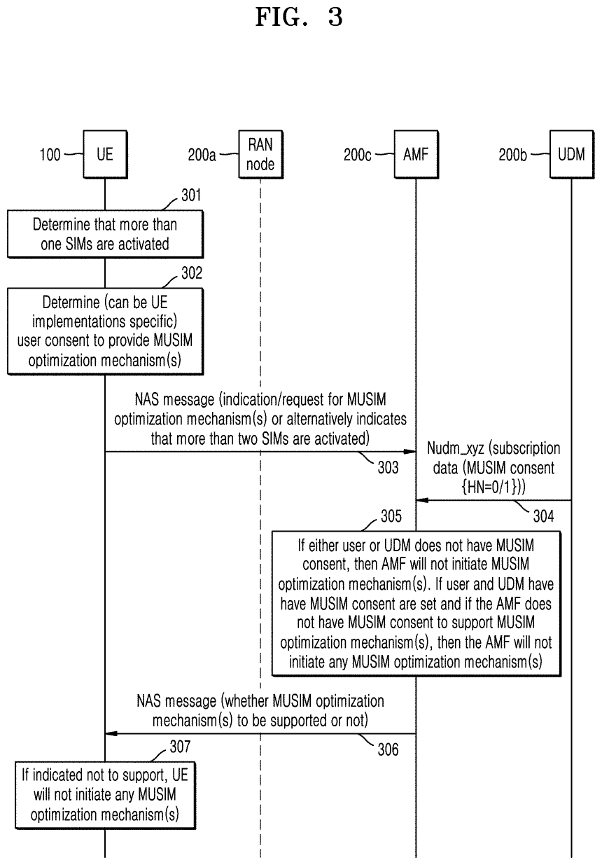

FIG. 3 is a sequence diagram illustrating an alternate method for initiating the MUSIM optimization, according to an embodiment as disclosed herein.

In this scenario, the UE (100) determines whether the user provided the consent for the MUSIM optimizations or not and the UE (100) determines more than one USIMs (150) are activated and provides the user consent details (i.e., whether or not the UE (100) supports and intends to use one or more Multi-USIM specific features) to the AMF (200c). Similarly, the UDM (200b) may provide the consent of the UDM (200b) or authorization of the UDM (200b) to the AMF (200c), to provide the MUSIM optimizations to the UE (100). The UDM (200b) may provide its consent or authorization to the AMF (200c) as part of the subscription data.

Based on the received user s consent and/or authorization, the AMF (200c) determines whether to provide the MUSIM optimizations or not and indicates a decision to the UE (100). Based on the indication of the AMF (200c), the UE (100) decides whether to support/use the MUSIM optimizations or not. If the user (i.e. the UE (100)) does not provide the consent or explicitly indicates no intend to disclose information associated with the UE (100), then the UE (100) and the network (200a/200b/200c) does not support/use the MUSIM optimizations.

At step 301, the UE (100) determines that more than one USIMs (150) are activated. At step 302, the UE (100) determines the user's consent/configuration information on whether the user provided user's willingness (intend) to obtain the MUSIM optimization. In an embodiment, for every initial registration procedure, the UE (100) requests the user s consent before initiating/using the MUSIM optimizations. Furthermore, the UE (100) determines the user s consent whether to initiate/request the MUSIM optimization or not from the USIM. The UDM (200b) may provide the USIM with the user's consent information/indication via over an air mechanism and/or via a remote SIM provisioning mechanism and/or using UE-parameter update via UDM-control plane procedure. The user-provided user s consent by some means to the UDM (200b). For example, during the subscription purchase process or indicated the user's consent to the UDM (200b) via the SMS or via the web interface to the portal of the UDM (200b).

At step 303, the UE (100) sends the MUSIM consent information (i.e., whether or not the UE (100) supports and intends to use one or more Multi-USIM specific features) and/or request for the MUSIM optimization in the NAS message to the AMF (200c). The NAS message may include an indication (i.e., whether or not the UE (100) supports and intends to use one or more Multi-USIM specific features) and/or request for the MUSIM optimization and/or may include an indication that more than one USIMs (150) are activated currently in the UE (100). At step 304, meanwhile, the UDM (200b) may provide the AMF (200c) with the subscription data in a service-based message (maybe part of the registration procedure). The subscription data optionally has the MUSIM consent/authorization information from the UDM (200b) that includes whether or not to use/provide the MUSIM optimization.

At step 305, if either the user s consent (provided by the UE (100)) or the UDM (200b) does not provide the consent/authorization, then the AMF (200c) does not proceed with the MUSIM related procedure (i.e. MUSIM optimization mechanism). If the user s consent authorization/indication are set (positive or authorized; (i.e., the UE (100) supports and intends to use one or more Multi-USIM specific features)) and the AMF (200c) does not support the MUSIM optimization, then the AMF (200c) does not initiate any MUSIM optimization mechanism.

At step 306, the AMF (200c) sends the registration accept message (e.g. NAS message) indicating to the UE (100) whether to support/initiate/request MUSIM optimization mechanism(s) or not. In an embodiment, the authorization information/indication for the MUSIM optimizations is provided by the AMF (200c) to the RAN (200a), using a UE context setup/modification procedure. Only if the RAN (200a) receives information/indication that the MUSIM optimization is authorized, then the RAN (200a) provides the MUSIM optimizations to the UE (100). At step 307, if indicated not to use any MUSIM optimization mechanism(s), then the UE (100) does not initiate/use any MUSIM optimization mechanism(s).

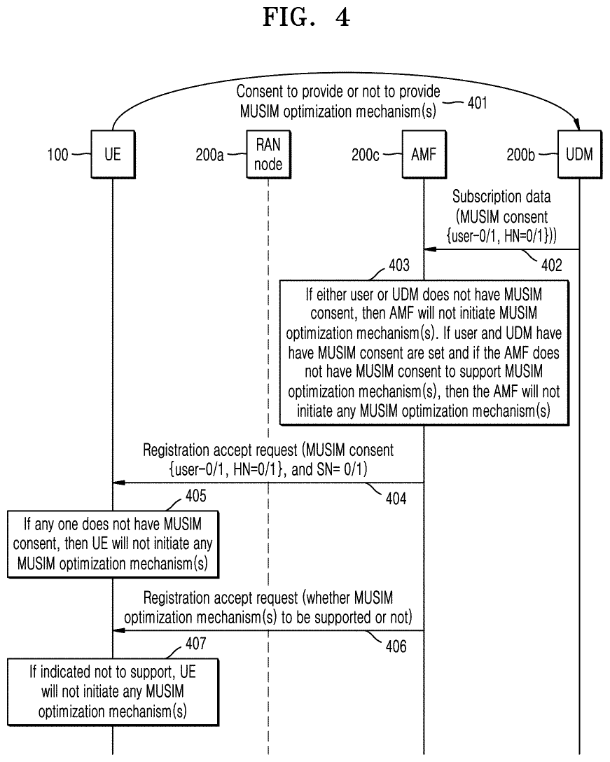

FIG. 4 is a sequence diagram illustrating an alternate method for initiating the MUSIM optimization, according to an embodiment as disclosed herein.

In this scenario, the UE (100) determines whether to initiate the MUSIM related procedures based on the user's consent, the UDM (200b), and/or the AMF (200c) authorization received from the network. In an alternate embodiment, the UDM (200b) provides the authorization to perform the MUSIM optimizations or not, to the UE (100) directly using UPU (UE Parameters Update) procedures. In another alternate embodiment, the UDM (200b) pre-configures whether to use the MUSIM optimizations or not in the USIM.

At step 401, the UE (100) provides the MUSIM consent information to the UDM (200b). The MUSIM consent information includes whether or not to provide/obtain the MUSIM optimization. At step 402, the UDM (200b) provides the AMF (200c) with the subscription data. The subscription data has the MUSIM consent information from the UDM (200b) that includes whether or not to use/provide the MUSIM optimization. Here “User” with a value “0” in the subscription data indicates that the user does not provide consent to provide the MUSIM optimizations. “User” with a value “1” in the subscription data indicates that the user-provided consent to provide the MUSIM optimizations. Similarly “HN” with a value “1” indicates that the UDM (200b) provides authorization, and “HN” with a value “0” indicated that the MUSIM optimization is not authorized by the UDM (200b). The illustrated representation is shown in Table 2.

TABLE 2

| Attribute | | |
|---|---|---|
| name | Data type | Description |
| MUSIMUser | Boolean | This indicates that user-provided |
| | | consent and the UE is allowed for |
| | | MUSIM optimization for the |
| | | associated USIM/subscription. |
| | | True or “1”: indicates that the UE is |
| | | allowed for MUSIM optimizations for |
| | | the associated USIM/subscription. |
| | | False or absent or “0”: indicates that |
| | | the UE is not allowed for MUSIM |
| | | optimizations for the associated |
| | | USIM/subscription. |
| MUSIMHN | Boolean | This indicates that the UE is allowed |
| | | for MUSIM optimization for the |
| | | associated USIM/subscription. |
| | | True or “1”: indicates that the UE is |
| | | allowed for MUSIM optimizations for |
| | | the associated USIM/subscription. |
| | | False or absent or “0”: indicates that |
| | | the UE is not allowed for MUSIM |
| | | optimizations for the associated |
| | | USIM/subscription. |

In an embodiment, the authorization of the UDM (200b) includes the user's consent information and there is no explicit indication for the user s consent or vice versa. The “HN” with value “1” indicates that the UDM (200b) provides authorization and the user-provides the user consent to provide the MUSIM optimizations. The “HN” with“0” indicates that the MUSIM optimization is not authorized by the UDM (200b) and/or the user does not provide consent. The illustrated representation is in Table 2.

At step 403, if either the users consent or authorization of the UDM (200b) is not provided, the AMF (200c) may not proceed with the MUSIM optimization mechanism(s). If both the user and the UDM (200b) indication are set (positive or authorized) and the AMF (200c) does not support the MUSIM optimization, then the AMF (200c) does not initiate any MUSIM optimization mechanism(s). At steps 404-405, the AMF (200c) indicates (using the NAS message, for example, the registration accept) to the UE (100) about the consent of the user, the UDM (200b), and the AMF (200c). If any of the consent/authorization is not set (positive or authorized), then the UE (100) may not support any MUSIM optimization mechanism(s).

At steps 406-407, alternatively, if the AMF (200c) indicates (using the NAS message, for example, the registration accept) to the UE (100), not to use any MUSIM related procedure (i.e. MUSIM optimization(s) is unauthorized), the UE (100) does not initiate the MUSIM optimization procedures. If the AMF (200c) indicates that the MUSIM optimization is authorized, then UE (100) initiates/requests any MUSIM optimization from the network (from the RAN (200a) or/and from the core network).

In this alternative steps 406-407, the AMF (200c) combines all the information into an indication, as authorized only if there is the user's consent, authorization from the UDM (200b), and the AMF (200c) based on the local policy may be provided by the PCF or available locally. If the user consent is not available or the UDM (200b) is not authorizing or local policy does not allow, then the AMF (200c) indicates to the UE (100), not to use any MUSIM optimization mechanism(s).

In an embodiment, only the user consent is considered for authorization for the MUSIM optimization for all the alternatives provided in this method.

In an embodiment, the authorization information/indication for the MUSIM optimizations is provided by the AMF (200c) to the RAN (200a), using the UE context setup/modification procedure. Only if the RAN (200a) receives the information/indication that the MUSIM optimization is authorized, the RAN (200a) provides the MUSIM optimizations to the UE (100).

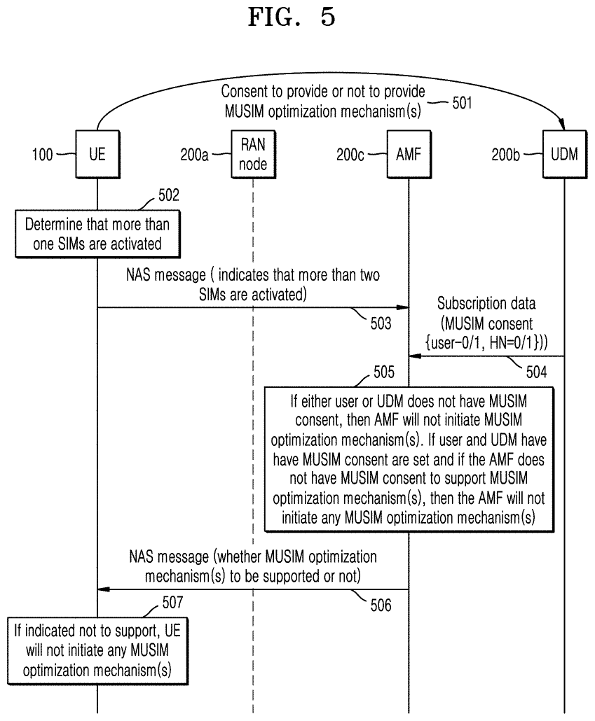

FIG. 5 is a sequence diagram illustrating an alternate method for initiating the MUSIM optimization, according to an embodiment as disclosed herein.

In this scenario, the user-provided users consent by some means to the UDM (200b). For example, during the subscription purchase process or indicated to the UDM (200b) via the SMS or the web interface to the portal of the UDM (200b). The UE (100) determines more than one USIMs (150) are activated, and provides the indication to the AMF (200c), that there is more than one USIMs (150) are activated. The UDM (200b) provides the details of the consent or authorization of the UDM (200b) to the AMF (200c), to provide the MUSIM optimizations to the UE (100). The UDM (200b) provides its consent or authorization to the AMF (200c) as part of the subscription data. Based on the received user consent and/or authorization, the AMF (200c) determines whether to provide the MUSIM optimizations or not, and indicates its decision to the UE (100). Based on the indication of the UE (100), the UE (100) decides whether to support the MUSIM optimizations or not. If the user does not provide the consent to disclose its information, then the UE (100) and network (200a/200/200c) do not support the MUSIM optimizations.

At step 501, the UE (100) provides the MUSIM consent information to the AMF (200c). The MUSIM consent information includes whether or not to provide the MUSIM optimization. At step 502, the UE (100) determines that more than one USIMs (150) are activated in the UE (100). At step 503, the UE (100) sends the NAS message which includes an indication that more than one USIMs (150) are activated currently, or UE request for the MUSIM optimizations (for example, the UE (100) sends an identifier for the registration context of the USIM1 (e.g. USIM1 Globally Unique Temporary ID(GUTI)).

At step 504, meanwhile, the UDM (200b) provides the AMF (200c) with the subscription data in the service-based message, as part of the registration procedure. The subscription data has the MUSIM consent information from the UDM (200b) that includes whether or not to use the MUSIM optimization mechanism(s). The UDM (200b) authorization includes the user consent information (e.g. user's consent and UDM's consent) also or only the user consent information. If the UDM (200b) indicates that the MUSIM is authorized then it means the UDM (200b) provides authorization and also indicates the user-provided consent to provide the MUSIM optimizations. If there is no MUSIM authorized indication/information, then it means the MUSIM optimization is not authorized by the UDM (200b) and/or the user does not provide consent. The illustrated representation is in Table 3.

TABLE 3

| Attribute | | |
|---|---|---|
| name | Data type | Description |
| MUSIMHN | Boolean | This indicates that the UE is allowed |
| | | for MUSIM optimization for the |
| | | associated USIM/subscription. |
| | | True or “1”: indicates that the UE is |
| | | allowed for MUSIM optimizations for |
| | | the associated USIM/subscription. |
| | | False or absent or “0”: indicates that |
| | | the UE is not allowed for MUSIM |
| | | optimizations for the associated |
| | | USIM/subscription. |

At step 505, if either the user or the UDM (200b) does not provide the consent, then the AMF (200c) may not proceed with the MUSIM optimization mechanism(s). If both the user and the UDM (200b) indication are set and the AMF (200c) does not support the MUSIM optimization, the AMF (200c) does not initiate any MUSIM optimization mechanism(s). At steps 506-507, the AMF (200c) sends the NAS message indicating to the UE (100) whether to support the MUSIM optimization mechanism(s) or not. If indicated to the UE (100) that not to use any MUSIM optimization mechanism(s), then the UE (100) may not initiate any such procedures. In an embodiment, the authorization information/indication for the MUSIM optimizations is provided by the AMF (200c) to the RAN (200b), using the UE context setup/modification procedure. Only if the RAN (200b) receives the information/indication that the MUSIM optimization is authorized, the RAN (200b) provides the MUSIM optimizations to the UE (100).

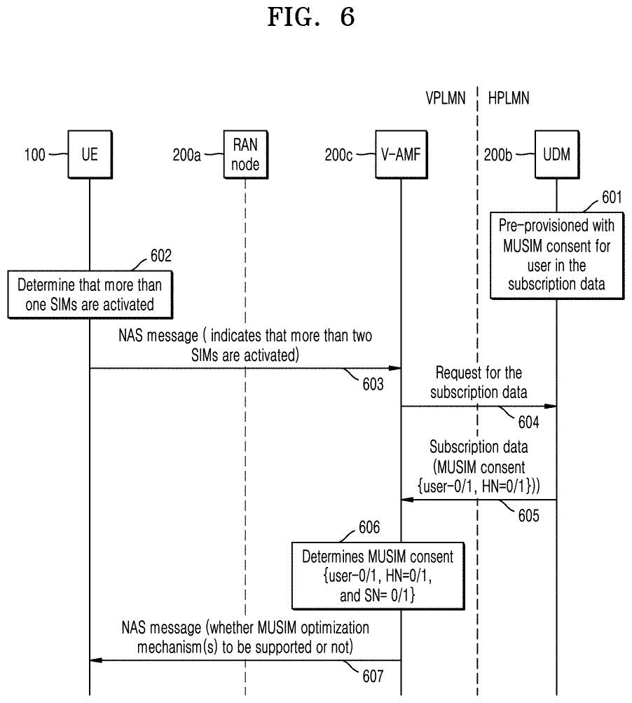

FIG. 6 is a sequence diagram illustrating an alternate method for initiating the MUSIM optimization, according to an embodiment as disclosed herein.

At step 601, the UDM (200b) is pre-provisioned with the users consent by an operator or by the user by some means to the UDM (200b). For example, during the subscription purchase process or indicated the user s consent to the UDM (200b) via the SMS or via the web interface to the portal of the UDM (200b). At step 602, the UE (100) determines more than one USIMs (150) are activated in the UE (100). At step 603, the UE (100) provides the indication to the AMF (200c) (e.g. Visitor (V)-AMF), that there are more than one USIMs (150) are activated and/or request for the MUSIM optimizations.

At step 604, based on the request of the UE (100) for the MUSIM optimizations, the AMF (200c) requests to the UDM (200b) for the subscription data. At step 605, the consent/authorization of the UDM (200b) and the user's consent are sent back to the AMF (200c) as a part of the subscription data request. At step 606, the AMF (200c) determines whether to provide the MUSIM optimizations to the UE (100) or not. Based on the received users consent and/or authorization from the UDM (200b) and/or the AMF (200c) (locally configuration policy or policy obtained from the PCF). The AMF (200c) determines whether to provide the MUSIM optimizations or not. At step 607, the AMF (200c) indicates its decision to the UE (100). Based on the indication of the AMF (200c), the UE (100) decides whether to support/initiate/request the MUSIM optimizations or not.

In an embodiment, another alternative for initiating the MUSIM optimization, in which the UE (100) is pre-configured with the information of the MUSIM optimizations to be used or not. For configuration of the MUSIM optimizations, the registration procedures perform as specified in 3GPP Technical Specification (TS) 23.502, the UE policy association establishment procedure as specified in the 3GPP TS 23.502 with the following additions:

a. If the UE (100) indicates in the capability of the UE (100) that the UE (100) supports the MUSIM optimization or currently two USIMs are active in the registration request message based on the UE (100) subscription data, then the AMF (200c) selects the PCF which can provides MUSIM related information and establishes the UE policy associated with the PCF.

b. If the AMF (200c) receives the capability that it supports the MUSIM optimization in the registration request message from the UE (100), then the AMF (200c) further reports the capability to the selected PCF.

c. The PCF determines whether to provide the MUSIM optimization information and provides the information to the UE (100) by using the procedure as defined in clause 4.2.4.3 “the UE (100) configuration update procedure for transparent UE Policy Delivery” in the 3GPP TS 23.502.

When the UE (100) is in roaming, the change of subscription results in updating the service authorization parameters which is further transferred to the UE (100) by the PCF in a home PLMN via a V-PCF in serving network.

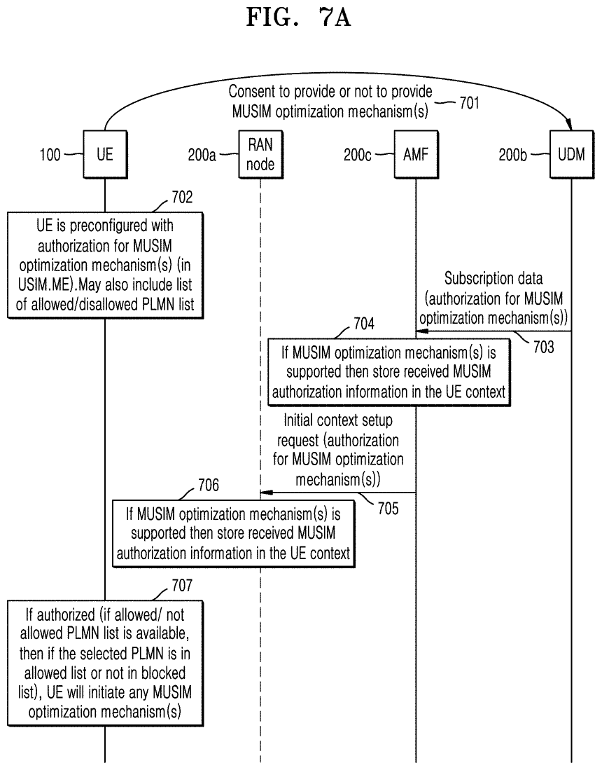

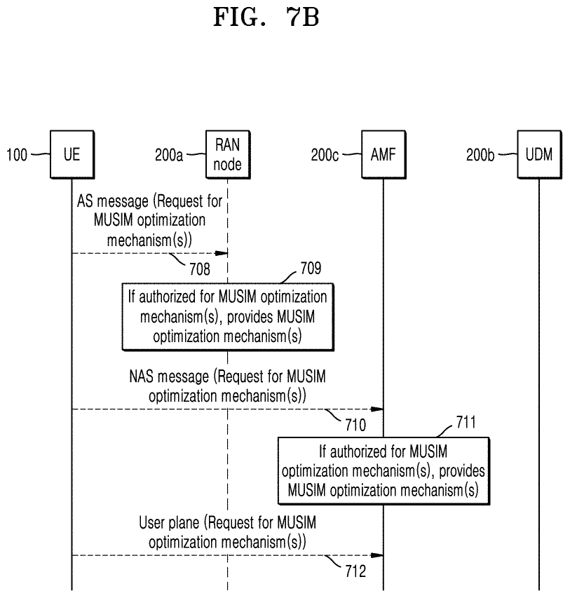

FIGS. 7A-7B are sequence diagrams illustrating an alternate method for initiating the MUSIM optimization, according to an embodiment as disclosed herein.

In this scenario, the user provides users consent by some means to the UDM (200b). For example, during the subscription purchase process or indicated the user s consent to the UDM (200b) via the SMS or via the web interface to the portal of the UDM (200b). The authorization information sharing with the network entities (200a/200b/200c) and the UE (100) is pre-configured with the authorization information for the MUSIM optimization (in the USIM or the UE (100)). The MUSIM optimization is purely based on support from both the UE (100) and the network entities (200a/200b/200c) based on the authorization results and the UE's indication to the RAN node (200a).

At steps 701-702, the user provides the MUSIM consent/willingness/configuration information to the UDM (200b). For example, the user/UE (100) is using an application or other means, such as visiting a store and manually signing. Then the mobile network operator fetches the information from the store or the information is provided to the operator's network by a storekeeper. In an embodiment, the UE (100) is pre-configured with authorization for the MUSIM optimization (in the USIM or UE (100)) and also the UE (100) is causing to include a list of allowed/disallowed PLMN list.

At step 703, the UDM (200b) provides the subscription data in the service-based message (e.g. Nudm service) to the AMF (200c) as a part of the registration procedure. The subscription data includes the authorization for the MUSIM optimization. At step 704, the AMF (200c) stores the MUSIM authorization information in the UE context received from the UDM (200b) when the MUSIM optimization is supported. At step 705, the AMF (200c) sends an N2 Application Protocol (N2AP) message (e.g. initial context setup request message) to the RAN node (200a). The N2AP message includes the authorization for the MUSIM optimizations.

At step 706, the RAN node (200a) stores the received MUSIM authorization information in the UE context for MUSIM optimization when the MUSIM optimization is supported. At step 707, if the UE (100) is authorized with the network (200a/200b/200c) (i.e. if the allowed or not allowed PLMNs list is available and the selected PLMN is in the allowed list or not in the blocked list), then the UE (100) may initiate any MUSIM optimization mechanism(s).

At step 708, the UE (100) sends the AS message request, which indicates the request for the MUSIM optimization to the RAN node (200a). At step 709, the RAN node (200a) provides the MUSIM optimization when the RAN node (200a) is authorized for the MUSIM procedures. At step 710, the UE (100) sends the request for the MUSIM optimization procedure in any NAS message to the AMF (200c). At step 711, the AMF (200c) provides the MUSIM optimization to the UE (100) after verification of the authorization of the UE (100) for the MUSIM optimization mechanism(s). At step 712, the UE (100) sends a user plane message to a data network (e.g. AMF (200c)), which indicates the request for the MUSIM optimization mechanism(s).

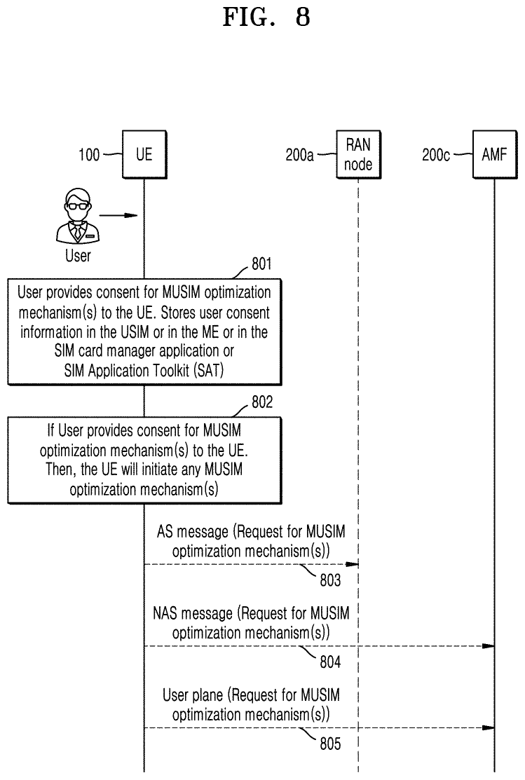

FIG. 8 is a sequence diagram illustrating an alternate method for initiating the MUSIM optimization, according to an embodiment as disclosed herein.

At step 801, the user provides users consent/configuration for the MUSIM optimization to the UE (100) (i.e., whether or not user intends to use one or more Multi-USIM specific features). The UE (100) stores the user consent information in the MUSIM or the UE (100)/ME or the SIM card manager or the SIM Application Toolkit (SAT) based on received input/consent/configuration/information from the user. The UE (100) requests for the user consent/configuration when the USIM is (re)activated or there is no information of the user input. The user can change consent/configuration whenever needed.

At step 802, the UE (100) may initiate/use any MUSIM optimization mechanism(s) when the user provides consent for the MUSIM optimization mechanism(s) to the UE (100). At step 803, the UE (100) may send the AS message request, which indicates the request for the MUSIM optimization to the RAN node (200a). At step 804, the UE (100) may send the NAS message request to the AMF (200c), which indicates the request for the MUSIM optimization to the AMF (200c) (i.e., whether or not the UE (100) supports and intends to use one or more Multi-USIM specific features). At step 805, the UE (100) sends the user plane request to the user plane entity for the MUSIM optimization. Based on the received indication of supported Multi-USIM features, the AMF (200c) indicate to the UE (100) the support of the Multi-USIM features based on the Multi-USIM features supported by network and any preference policy by the network, if available in the NAS message (as detailed in step 306). In an embodiment, the NAS message being at least one of a registration request, a service request, a PDU Session establishment request message.

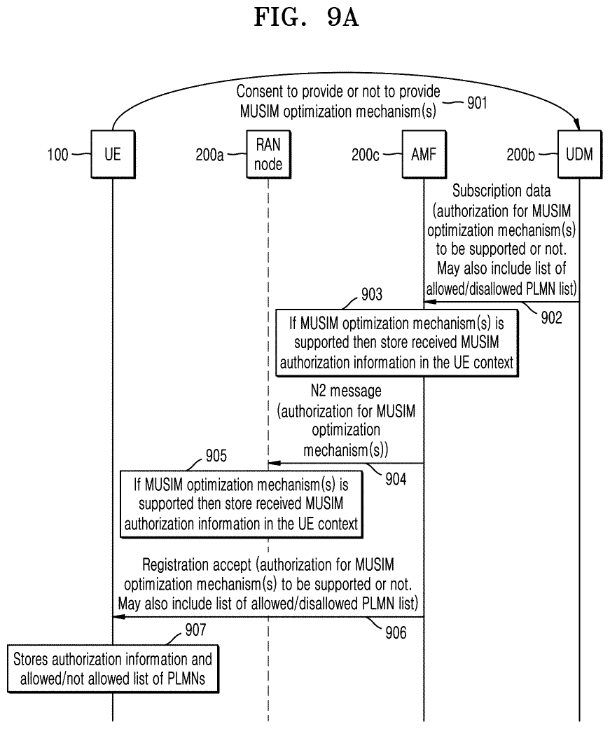

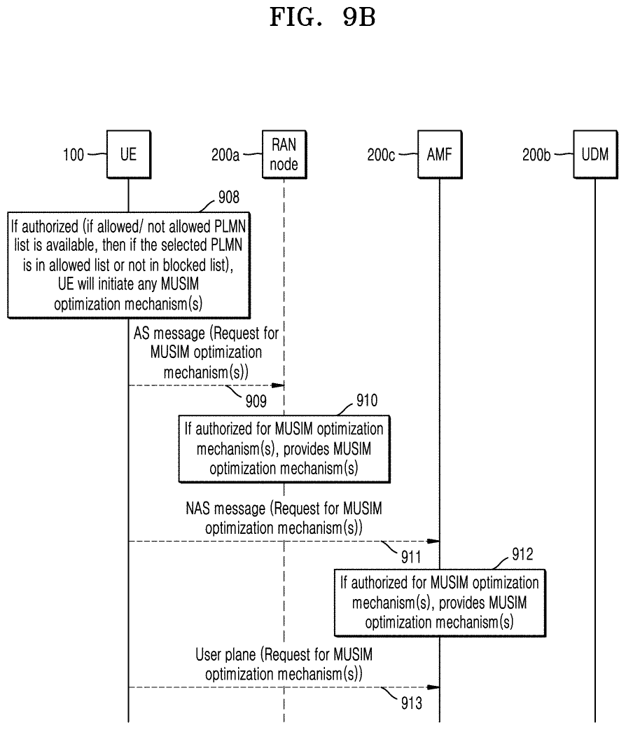

FIGS. 9A-9B are sequence diagrams illustrating an alternate method for initiating the MUSIM optimization, according to an embodiment as disclosed herein.

At step 901, the user of the UE (100) provides the MUSIM consent information to the UDM (200b). The MUSIM consent information includes whether or not to provide/obtain MUSIM optimization. At step 902, the UDM (200b) provides the subscription data to the AMF (200c), which includes the MUSIM consent information from the UDM (200b) that includes whether or not, use/provide the MUSIM optimization mechanism(s). The subscription data may also include the list of allowed or disallowed PLMN for the MUSIM optimization. At step 903, if the AMF (200c) supports the MUSIM optimization mechanism(s) then the AMF (200c) stores the MUSIM authorization information received from the UDM (200b) in the UE context. At step 904, the AMF (200c) sends a N2 message indicating about the authorization for the MUSIM optimization to the RAN (200a).

At step 905, if the RAN (200a) supports the MUSIM optimization then the RAN (200a) stores the MUSIM authorization information received from the UDM (200b) in the UE context. At step 906, the AMF (200c) indicates (using the NAS message, for example, the registration accept) to the UE (100) about the MUSIM consent information from the UDM (200b) that includes whether or not, use/provide the MUSIM procedure and the list of allowed or disallowed PLMN for MUSIM optimization. At step 907, on receiving the indication from the AMF (200c), the UE (100) stores the received MUSIM consent information and the list of allowed or disallowed PLMN for the MUSIM optimization. At step 908, if the UE (100) is authorized for the MUSIM optimization procedures, the UE (100) has the list of allowed/disallowed PLMN, and the UE (100) has selected an allowed PLMN for camping then the UE (100) is allowed to perform any MUSIM optimization mechanism(s).

At step 909, the UE (100) sends the AS message request, which indicates the request for the MUSIM optimization to the RAN node (200a). At step 910, the RAN node (200a) provides the MUSIM optimization when the RAN node (200a) is authorized for the MUSIM procedures. At step 911, the UE (100) sends the request for MUSIM optimization procedure in any NAS message to the AMF (200c). At step 912, the AMF (200c) provides the UE (100) with the MUSIM optimization after verification of the authorization of the UE (100) for the MUSIM optimization mechanism(s). At step 913, the UE (100) sends the user plane message to the data network, which indicates the request for the MUSIM optimization mechanism(s).

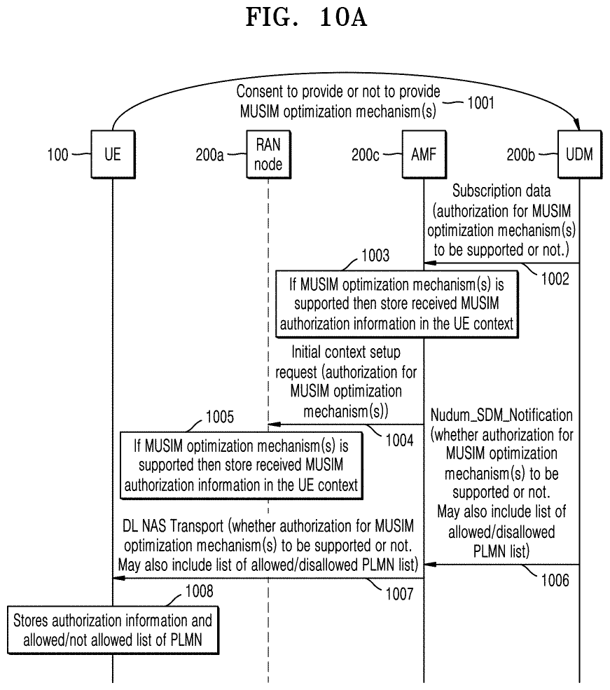

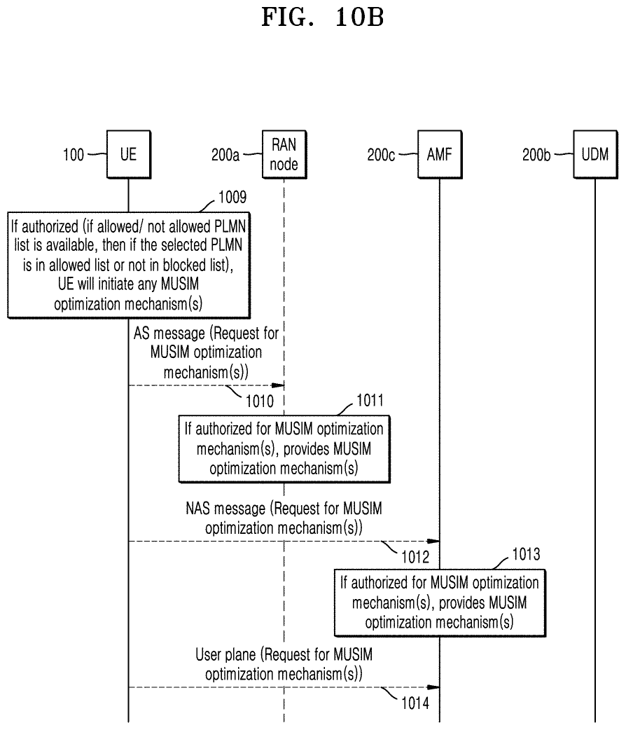

FIGS. 10A-10B are sequence diagrams illustrating an alternate method for initiating the MUSIM optimization, according to an embodiment as disclosed herein.

At step 1001, the user of the UE (100) provides the MUSIM consent information to the UDM (200b). The MUSIM consent information includes whether or not to provide/obtain MUSIM optimization. At step 1002, the UDM (200b) provides the subscription data to the AMF (200c), which includes the MUSIM consent information from the UDM (200b) that includes whether or not, use/provide the MUSIM optimization mechanism(s). At step 1003, if the AMF (200c) supports the MUSIM optimization mechanism(s) then the AMF (200c) stores the MUSIM authorization information received from the UDM (200b) in the UE context. At step 1004, the AMF (200c) sends the N2 message (initial context setup request) indicating the authorization for the MUSIM optimization to the RAN (200a).

At step 1005, if the RAN (200a) supports the MUSIM optimization then the RAN (200a) stores the MUSIM authorization information received from the UDM (200b) in the UE context. At step 1006, the UDM (200b) notifies the changes of the information related to the UE (100) to the AMF (200c) by means of invoking Nudm_SDM_Notification service operation. The Nudm_SDM_Notification service operation contains the UDM's (200b) update data (e.g. “Routing Indicator update data”, “Default Configured NSSAI update data”, additionally “MUSIM Authorization”) that needs to be delivered transparently to the UE (100) over NAS within access and mobility subscription data. The UDM's (200b) update data includes one or more UE parameters as follows:

a. The (updated) MUSIM authorization (final consumer of the parameter is the UE (100)/USIM).

b. The list of allowed/disallowed PLMN (final consumer of the parameter is the UE (100)/USIM).

At step 1007, the AMF (200c) sends a DL NAS TRANSPORT message to the served UE (100). The AMF (200c) is causing to include in the DL NAS TRANSPORT message the transparent container received from the UDM (200b). At step 1008, upon receiving the DL NAS TRANSPORT message from the AMF (200c), the UE (100) stores the received MUSIM consent information and the list of allowed or disallowed PLMN for the MUSIM optimization. At step 1009, if the UE (100) is authorized for the MUSIM optimization procedures, the UE (100) has the list of allowed/disallowed PLMN, and the UE (100) has selected an allowed PLMN. Then the UE (100) is allowed to perform any MUSIM optimization mechanism(s).

At step 1010, the UE (100) sends the AS message request, which indicates the request for the MUSIM optimization to the RAN node (200a). At step 1011, the RAN node (200a) provides the MUSIM optimization when the RAN node (200a) is authorized for the MUSIM procedures. At step 1012, the UE (100) sends the request for MUSIM optimization procedure in any NAS message to the AMF (200c). At step 1013, the AMF (200c) provides the UE (100) with the MUSIM optimization after verification of the authorization of the UE (100) for the MUSIM optimization mechanism(s). At step 1014, the UE (100) sends the user plane message to the data network, which indicates the request for the MUSIM optimization mechanism(s).

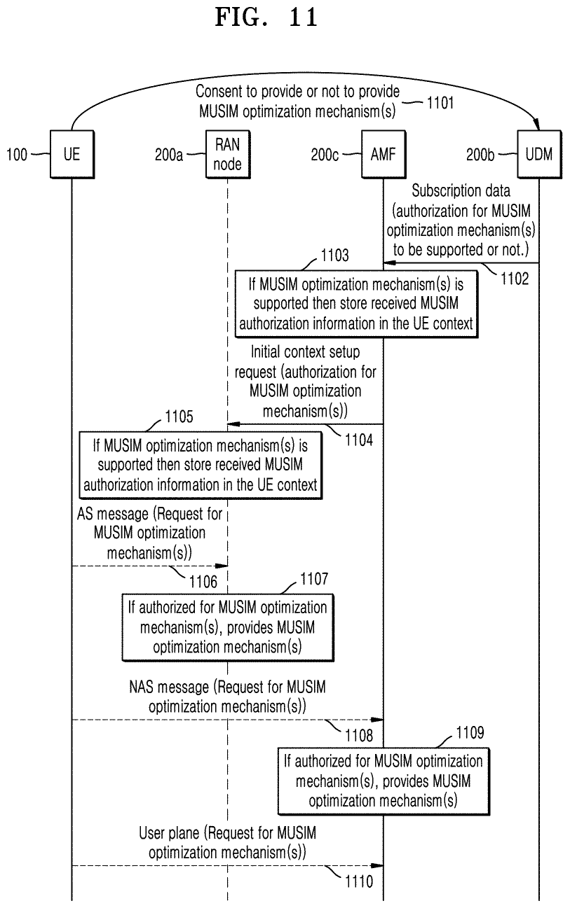

FIG. 11 is a sequence diagram illustrating an alternate method for initiating the MUSIM optimization, according to an embodiment as disclosed herein.

At step 1101, the user of the UE (100) provides the MUSIM consent information to the UDM (200b). The MUSIM consent information includes whether or not to provide/obtain MUSIM optimization. At step 1102, the UDM (200b) provides the subscription data to the AMF (200c), which includes the MUSIM consent information from the UDM (200b) that includes whether or not, use/provide the MUSIM optimization mechanism(s). At step 1103, if the AMF (200c) supports the MUSIM optimization mechanism(s) then the AMF (200c) stores the MUSIM authorization information received from the UDM (200b) in the UE context. At step 1104, the AMF (200c) sends the N2 message (initial context setup request) indicating the authorization for the MUSIM optimization to the RAN (200a).

At step 1105, if the RAN (200a) supports the MUSIM optimization then the RAN (200a) stores the MUSIM authorization information received from the UDM (200b) in the UE context. At step 1106, the UE (100) sends the AS message request, which indicates the request for the MUSIM optimization to the RAN node (200a). At step 1107, the RAN node (200a) provides the MUSIM optimization when the RAN node (200a) is authorized for the MUSIM procedures. At step 1108, the UE (100) sends the request for the MUSIM optimization procedure in any NAS message to the AMF (200c). At step 1109, the AMF (200c) provides the UE (100) with the MUSIM optimization after verification of the authorization of the UE (100) for the MUSIM optimization mechanism(s). At step 1110, the UE (100) sends the user plane message to the data network, which indicates the request for the MUSIM optimization mechanism(s).

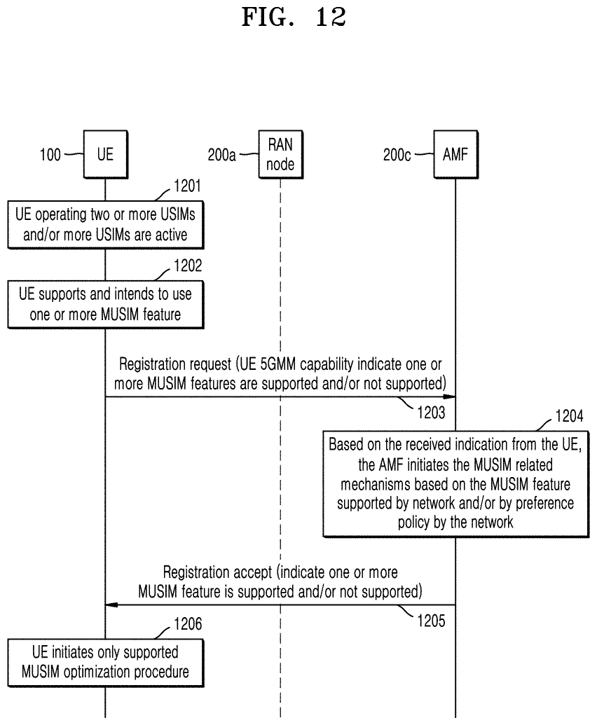

FIG. 12 is a sequence diagram illustrating an alternate method for initiating the MUSIM optimization, according to an embodiment as disclosed herein.

In this scenario, the method is assumed that the UE (100) and the AMF (200c) (i.e. Serving Network (SN)) supports one or more MUSIM feature. However, when a Multi-USIM UE has more than one USIM (150) active, supports and intends to use one or more Multi-USIM specific features, it indicates to the AMF (200c) the corresponding Multi-USIM feature(s) are supported. Based on the received indication of supported Multi-USIM features from the UE (100), the AMF (200c) indicates to the UE (100) the support of the Multi-USIM features based on the Multi-USIM features if supported by the network.

In an embodiment, the AMF (200c) decides the support of the MUSIM feature based on a pre-configured local policy and/or any preference policy.

At step 1201, the UE (100) determines if multiple USIMs (150) activated or not. At step 1202, the UE (100) determines if one or more MUSIM features supported or not and whether or not the UE (100) intends to use one or more Multi-USIM specific features.

At step 1203, the UE (100) includes the indication that one or more MUSIM feature supported and intended to use by the UE (100) to the AMF (200c) in the registration request message.

In an embodiment, UE (100) provides the MUSIM consent (i.e., whether or not the UE (100) supports and intends to use one or more Multi-USIM specific features) via the RAN node (200a) to the AMF (200c) in the registration request message.

In an embodiment, the MUSIM features such as the connection release supported, the paging cause supported, the paging restriction supported, the reject paging supported, are indicated in the registration request in the UE network capability to the AMF (200c).

At step 1204, based on the received indication of supported Multi-USIM features from the UE (100), the AMF (200c) determines the support of the Multi-USIM features based on the Multi-USIM features if supported or not by the network or its local policy or preference policy.

In an embodiment, if the AMF (200c) supports one or more MUSIM feature then at step 1205, the AMF (200c) sends the indication of supported the MUSIM feature in registration accept message.

In another embodiment, the AMF (200c) indicated the support of MUSIM optimization procedure in existing NAS message/N2 message/any new NAS message.

At Step 1206, the UE (100) uses MUSIM related procedure for the indicated MUSIM features supported by the AMF (200c) in step 1205. If the AMF (200c) does not support the MUSIM optimization, then UE (100) does not use the MUSIM features.

The various actions, acts, blocks, steps, or the like in the sequence diagrams (FIG. 2 to FIG. 12) may be performed in the order presented, in a different order or simultaneously. Further, in some embodiments, some of the actions, acts, blocks, steps, or the like may be omitted, added, modified, skipped, or the like without departing from the scope of the disclosure.

The embodiments disclosed herein can be implemented using at least one hardware device and performing network management functions to control the elements.

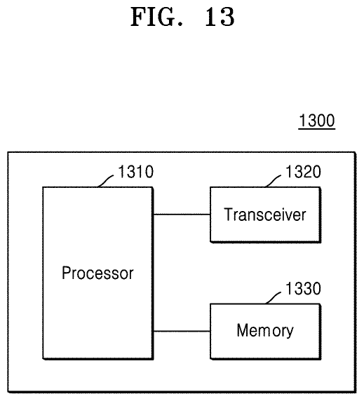

FIG. 13 schematically illustrates a user equipment (UE) according to embodiments of the present disclosure.

Referring to the FIG. 13, the UE 1300 may include a processor 1310, a transceiver 1320 and a memory 1330. However, all of the illustrated components are not essential. The Base station 1300 may be implemented by more or less components than those illustrated in FIG. 13. In addition, the processor 1310 and the transceiver 1320 and the memory 1330 may be implemented as a single chip according to another embodiment.

The aforementioned components will now be described in detail.

The processor 1310 may include one or more processors or other processing devices that control the proposed function, process, and/or method. Operation of the UE 1300 may be implemented by the processor 1310.

The transceiver 1320 may include a RF transmitter for up-converting and amplifying a transmitted signal, and a RF receiver for down-converting a frequency of a received signal. However, according to another embodiment, the transceiver 1320 may be implemented by more or less components than those illustrated in components.

The transceiver 1320 may be connected to the processor 1310 and transmit and/or receive a signal. The signal may include control information and data. In addition, the transceiver 1320 may receive the signal through a wireless channel and output the signal to the processor 1310. The transceiver 1320 may transmit a signal output from the processor 1310 through the wireless channel.

The memory 1330 may store the control information or the data included in a signal obtained by the UE 1300. The memory 1330 may be connected to the processor 1310 and store at least one instruction or a protocol or a parameter for the proposed function, process, and/or method. The memory 1330 may include read-only memory (ROM) and/or random access memory (RAM) and/or hard disk and/or CD-ROM and/or DVD and/or other storage devices.

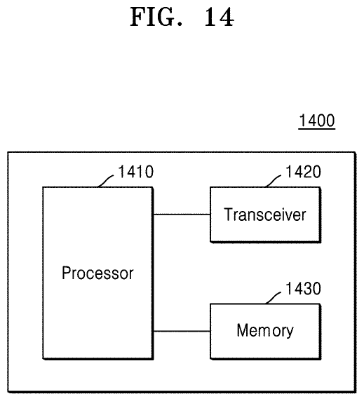

FIG. 14 illustrates a base station (BS) according to embodiments of the present disclosure.

Referring to the FIG. 14, the BS 1400 may include a processor 1410, a transceiver 1420 and a memory 1430. However, all of the illustrated components are not essential. The BS 1400 may be implemented by more or less components than those illustrated in FIG. 14. In addition, the processor 1410 and the transceiver 1420 and the memory 1430 may be implemented as a single chip according to another embodiment.

The aforementioned components will now be described in detail.

The processor 1410 may include one or more processors or other processing devices that control the proposed function, process, and/or method. Operation of the BS 1400 may be implemented by the processor 1410.

The transceiver 1420 may include a RF transmitter for up-converting and amplifying a transmitted signal, and a RF receiver for down-converting a frequency of a received signal. However, according to another embodiment, the transceiver 1420 may be implemented by more or less components than those illustrated in components.

The transceiver 1420 may be connected to the processor 1410 and transmit and/or receive a signal. The signal may include control information and data. In addition, the transceiver 1420 may receive the signal through a wireless channel and output the signal to the processor 1410. The transceiver 1420 may transmit a signal output from the processor 1410 through the wireless channel.

The memory 1430 may store the control information or the data included in a signal obtained by the BS 1400. The memory 1430 may be connected to the processor 1410 and store at least one instruction or a protocol or a parameter for the proposed function, process, and/or method. The memory 1430 may include read-only memory (ROM) and/or random access memory (RAM) and/or hard disk and/or CD-ROM and/or DVD and/or other storage devices.

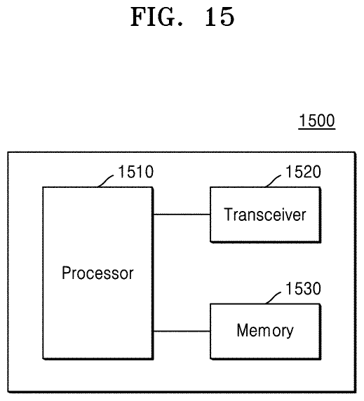

FIG. 15 illustrates an entity according to embodiments of the present disclosure.

Referring to the FIG. 15, the ENTITY 1500 may include a processor 1510, a transceiver 1520 and a memory 1530. However, all of the illustrated components are not essential. The ENTITY 1500 may be implemented by more or less components than those illustrated in FIG. 15. In addition, the processor 1510 and the transceiver 1520 and the memory 1530 may be implemented as a single chip according to another embodiment.

The aforementioned components will now be described in detail.

The processor 1510 may include one or more processors or other processing devices that control the proposed function, process, and/or method. Operation of the ENTITY 1500 may be implemented by the processor 1510.

The transceiver 1520 may include a RF transmitter for up-converting and amplifying a transmitted signal, and a RF receiver for down-converting a frequency of a received signal. However, according to another embodiment, the transceiver 1520 may be implemented by more or less components than those illustrated in components.

The transceiver 1520 may be connected to the processor 1510 and transmit and/or receive a signal. The signal may include control information and data. In addition, the transceiver 1520 may receive the signal through a wireless channel and output the signal to the processor 1510. The transceiver 1520 may transmit a signal output from the processor 1510 through the wireless channel.

The memory 1530 may store the control information or the data included in a signal obtained by the ENTITY 1500. The memory 1530 may be connected to the processor 1510 and store at least one instruction or a protocol or a parameter for the proposed function, process, and/or method. The memory 1530 may include read-only memory (ROM) and/or random access memory (RAM) and/or hard disk and/or CD-ROM and/or DVD and/or other storage devices.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
identifying whether the UE supports and intends to use at least one multi-universal subscriber identity module (USIM) feature;
transmitting, to an access and mobility management function (AMF) entity, a registration request message including information of multi-USIM features supported by the UE, in a case that the at least one multi-USIM feature being supported and intended to use by the UE is identified;
receiving, from a base station (BS), a registration accept message including an indication of multi-USIM features for the UE based on the registration request message, and wherein the indication of multi-USIM features for the UE is identified by the AMF based on network information and the information of multi-USIM features; and
identifying at least one multi-USIM feature indicated as supported for the UE by the AMF based on the registration accept message.

2. The method of claim 1,
wherein the information of multi-USIM features supported by the UE includes the at least one multi-USIM feature being supported and intended to use by the UE, and
wherein the at least one multi-USIM feature corresponds to a connection release, a paging cause, a paging restriction, or a reject paging.

3. The method of claim 1, wherein the indication of multi-USIM features for the UE includes at least one multi-USIM feature being supported and intended to apply to the UE by the AMF, and
wherein the at least one multi-USIM feature corresponds to a connection release, a paging cause, a paging restriction, or a reject paging.

4. The method of claim 1, wherein identifying whether the UE supports and intends to use the at least one multi-USIM feature comprises:
identifying whether at least one USIM is active among at least two operating USIMs.

5. The method of claim 1, wherein the indication of multi-USIM features for the UE is included in an N2 message from the AMF to the BS.

6. The method of claim 1, wherein the indication of multi-USIM feature for the UE is identified by the AMF based on at least one of a network capability, a pre-configured local policy, or a preference policy.

7. The method of claim 1, wherein at least one multi-USIM feature indicated as supported for the UE is apply for at least one USIM among at least two operating USIMs.

8. A method performed by an access and mobility management function (AMF) entity in a wireless communication system, the method comprising:
receiving, from a user equipment (UE), a registration request message including information of multi-USIM features supported by the UE, in a case that the at least one multi-USIM feature being supported and intended to use by the UE is identified by the UE;
identifying an indication of multi-USIM features for the UE based on network information and the information of multi-USIM features; and
transmitting, to a base station (BS), a message including the indication of multi-USIM features for the UE, wherein at least one multi-USIM feature indicated as supported for the UE by the AMF is identified based on the registration accept message.

9. The method of claim 8,
wherein the information of multi-USIM features supported by the UE includes the at least one multi-USIM feature being supported and intended to use by the UE, and
wherein the at least one multi-USIM feature corresponds to a connection release, a paging cause, a paging restriction, or a reject paging.

10. The method of claim 8, wherein the indication of multi-USIM features for the UE includes at least one multi-USIM feature being supported and intended to apply to the UE by the AMF, and
wherein the at least one multi-USIM feature corresponds to a connection release, a paging cause, a paging restriction, or a reject paging.

11. The method of claim 8, wherein whether at least one USIM is active among at least two operating USIMs is identified by the UE.

12. The method of claim 8, wherein the indication of multi-USIM features for the UE is transmitted to the UE by the BS.

13. The method of claim 8, wherein identifying the indication of multi-USIM features for the UE based on the network information and the information of multi-USIM features comprises:
identifying the indication of multi-USIM feature for the UE based on at least one of a network capability, a pre-configured local policy, or a preference policy.

14. The method of claim 8, wherein at least one multi-USIM feature indicated as supported for the UE is apply for at least one USIM among at least two operating USIMs by the UE.

15. A user equipment (UE) in a wireless communication system, the UE comprising:
a transceiver; and
at least one processor coupled with the transceiver and configured to:
identify whether the UE supports and intends to use at least one multi-universal subscriber identity module (USIM) feature,
transmit, to an access and mobility management function (AMF) entity, a registration request message including information of multi-USIM features supported by the UE, in a case that the at least one multi-USIM feature being supported and intended to use by the UE is identified,
receive, from a base station (BS), a registration accept message including an indication of multi-USIM features for the UE based on the registration request message, and wherein the indication of multi-USIM features for the UE is identified by the AMF based on network information and the information of multi-USIM features, and
identify at least one multi-USIM feature indicated as supported for the UE by the AMF based on the registration accept message.

16. The UE of claim 15,
wherein the information of multi-USIM features supported by the UE includes the at least one multi-USIM feature being supported and intended to use by the UE, and
wherein the at least one multi-USIM feature corresponds to a connection release, a paging cause, a paging restriction, or a reject paging.

17. The UE of claim 15, wherein the indication of multi-USIM features for the UE includes at least one multi-USIM feature being supported and intended to apply to the UE by the AMF, and
wherein the at least one multi-USIM feature corresponds to a connection release, a paging cause, a paging restriction, or a reject paging.

18. The UE of claim 15, wherein the at least one processor is configured to:
identify whether at least one USIM is active among at least two operating USIMs.

19. The UE of claim 15, wherein the indication of multi-USIM feature for the UE is identified by the AMF based on at least one of a network capability, a pre-configured local policy, or a preference policy.

20. The UE of claim 15, wherein at least one multi-USIM feature indicated as supported for the UE is apply for at least one USIM among at least two operating USIMs.
